(19) United States
(12) Patent Application Publication
(10) Pub. No.: US 2013/0059618 A1
(43) Pub. Date: Mar. 7, 2013

(54) METHOD AND ARCHITECTURE FOR VERY HIGH CAPACITY WIRELESS ACCESS USING ACTIVE ELECTRONIC SCANNED ARRAY (AESA)

(71) Applicants: Carl Cao, San Jose, CA (US); Sidney Lee Weatherford, Richardson, TX (US)

(72) Inventors: Carl Cao, San Jose, CA (US); Sidney Lee Weatherford, Richardson, TX (US)

(21) Appl. No.: 13/445,580

(22) Filed: Apr. 12, 2012

Related U.S. Application Data
(60) Provisional application No. 61/531,286, filed on Sep. 6, 2011.

(51) Int. Cl. H04W 56/00; H04W 88/08; H04W 72/04

(52) U.S. Cl. 455/509; 455/507

(57) ABSTRACT

A base station in a network includes an Active Electronic Scanned Array (AESA) to enhance and increase transmission and reception in a wireless telecommunications network. The AESA comprises a plurality of transmitter and receiver modules for sending and receiving signals from a User Equipment (UE) with increased signal strength and higher gain. The AESA comprises a central controller; and subcontrollers that cause signals to be directed to specific transmission modules (TxMs) and receiver modules (RxMs) in the AESA to send to the UE. By increasing the number of TxMs used, the signal strength to the UE can be increased significantly. Subcontrollers for handling different radio frequencies can be utilized in the same AESA so that multiple telecommunication systems can be accommodated on a single base station.

### CROSS-REFERENCE TO RELATED APPLICATIONS

This application claims the benefit of U.S. Provisional Application No. 61/531,286, filed Sep. 6, 2011, the disclosure of which is incorporated herein by reference.

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND

Commercial wireless networks have evolved through several generations today with the latest fourth generation (4G) cellular wireless network based on OFDMA and MIMO antenna technology being optimized for packet data transmission, which is expected to dominate the overall volume of wireless network traffic. In addition to the large increases in data traffic, voice can also be supported by carrying speech frames as Voice-over-IP. However, data traffic has become the main driver for increasing wireless capacity. With the explosive adoption of smart phones and similar devices there is an increasing need for more and more data capacity.

Data applications are asymmetric there being much more demand for downlink capacity than for uplink capacity. This is also consistent with the flexibility in transmission equipment that can be supported by a cellular wireless network where the downlink transmission power from the Base Station (BS) to the User Equipment (UE) is much higher than the uplink transmission power from the UE to the Base Station.

Existing wireless technologies (e.g., CDMA HRPD, WCDMA HSDPA, and OFDMA, i.e., LTE and WiMAX) all have limitations due to underlying transmission technology. While OFDMA may theoretically have much higher transmission capacity over the same frequency range, it can be further improved by juxtopositioning various “flavors” of Smart Antenna and MIMO technologies, but these technologies are still fundamentally limited by legacy wireless network architecture.

The amount of data traffic in the current 4G and 3G networks has grown exponentially especially given the mass adoption of smart phones and other mobile devices. Yet, the RF spectrum that can be used commercially is limited and in North America the utilization of available spectrum is already near 80%. There is therefore a clear need for additional capacity per MHz of spectrum.

The Active Electronic Scanned Array (AESA) technology provides a means to fundamentally update the wireless network architecture, in particular that at the cell level and it provides the potential to increase network capacity significantly.

### SUMMARY

The present invention solves the problem of providing additional capacity by introducing a Base Station in a cellular wireless network that comprises one or more Active Electronic Scanned Arrays (AESA), each of which comprises a plurality of transmitter modules (TxM), for transmitting a RF signal to a UE, each TxM for use with at least one other corresponding TxM, each TxM being spaced apart a distance equal to a function of a Radio Frequency (RF) wavelength used by a UE and the Base Station. An AESA also comprises a plurality of receiver modules (RxMs), for receiving a RF signal from the UE, each RxM for use with at least one other corresponding RxM, each RxM being spaced apart a distance equal to a function of the RF wavelength used by the UE and the Base Station.

An AESA can comprise a plurality of transmitter-receiver modules (TRM), each of which includes a physically combined transmitter, for transmitting a RF signal to a UE, and a receiver, for receiving a RF signal from the UE. The TRMs are spaced apart a distance equal to a function of the RF wavelength used by the UE and the Base Station.

The UE transmits, by using its TxM/TRM, a logical control channel that contains messages of its RF channel feedback. The Base Station, on receiving and decoding such information from the UE can adjust phase alignment of a group of two or more TxMs/TRMs for subsequently transmitting RF signals to the UE. In the opposite direction, the Base Station may also transmit such a logical control channel including similar kind of control information to the UE and to allow the UE to adjust phase alignment of the modules of the UE AESA.

The RF channel between the Base Station and the UE consists of two types of logical channels, i.e., the aforementioned logical control channel and the user traffic channel. The specific wireless technology, e.g., WCDMA, CDMA, WiMax, and LTE, may be designed with one or more logical control channels, and a plurality of traffic channels.

A controller for the AESA, as part of the Base Station, comprises an interface to be connected with the plurality of TxMs and the plurality of RxMs. In the AESA with the TRMs, the controller is connected with the combined TRMs. In the transmission direction, the controller steers the phase alignment of the at least two TxMs (or TRMs), on one of the AESA arrays, for transmitting signals to the UE. The controller determines the direction and the compactness of the electromagnetic field carrying the RF signal through the desired phase alignment. The controller also selects the number of TxMs (or TRMs), when combined through phase alignment, to provide a more, or less, sharply focused signal, and a stronger, or a weaker, signal which leads to increased, or decreased, data transfer rate and increased, or decreased, transmission range to the UE.

In the receiving direction, the controller steers the phase alignment of at least two RxMs (or TRMs) for receiving from the UE. It determines the direction of the RF signal to receive and the number of RxMs (or TRMs) for the specific UE to achieve a more, or less, sharply focused received signal, or a higher, or lower, signal gain.

Through coordinating all the transmission to and receiving from all UEs, and the transmission and receiving TxMs (or TRMs) and RxMs (or TRMs), the controller maximizes the aggregate data transfer rate over the cell covered by the Base Station.

The controller can be designed to operate in one or more layers. A controller may be connected to a sub-controller wherein the sub-controller is coupled with the TxMs, and the RxMs, or the combined TRMs of an AESA array. The sub-controller directly steers the TxMs and the RxMs, or TRMs. Hence, the main controller itself controls them indirectly, but can perform a more coordinating function; this allows the overall architecture to be scalable when necessary.

In another aspect of the invention, a method is provided for increasing transmission and reception capacity, by utilizing an AESA array in a node in the wireless network, where the AESA is coupled to a controller for controlling independent TxMs of the AESA. The controller selects a subset of the modules dynamically based on their location, geometry, and distance to each other measured as a function of the said RF wavelength in response to the UE provided UE RF channel feedback, via a logical control channel, the RF channel feedback being used for adjusting the phase alignment of the modules and optimizing the aggregate power level to maximize the data transfer rate, where the phase alignment controls the direction of transmission of the compatible RF signals to the UE and the number of selected sets of modules controls the sharpness of the signal and the aggregate power targeted at the UE.

In a further aspect of the present invention a controller is introduced. The controller controls multiple subsets of TxMs of the AESA array, where each subset is a group of TxMs selected based on their location, geometry, and distance to each other measured as a function of the said RF wavelength in response to the UE provided RF channel feedback. Each subset of TxMs transmits with compliance to a specific wireless technology standard, including GSM, WCDMA, CDMA, WiMAX, LTE, and their evolved standards to the UE capable of receiving and transmitting in the compatible technology. The selection of these TxM subsets are dynamic and based on the current RF environment characterized by the RF parameters in the system including the location of the UE and the UE's channel matrix.

The single Base Station supports multiple wireless technology standards at the same time by selecting different TxM subsets and transmitting according to the said technology standard over each subset. The controller includes broadcasting and detecting means for the particular radio technology of the UE and scheduling logic operating in a processor with an associated memory that selects one of the plurality of physical or logical sub-controllers that corresponds with the radio technology of the UE. Each sub-controller comprises the logic means for selecting one or more TxMs in the shared pool of such modules of the AESA to transmit a part of or a full frequency band specific to the UE. The number, location, geometry, and distance, to each other of these modules, measured as a function of the said RF wavelength in response to the UE provided UE RF channel feedback, via a logical control channel, are controlled to optimize the desired direction of transmission to the UE and the aggregate power targeted at the UE to maximize the data transfer rate.

In further aspect of the invention, a method is provided for increasing transmission and reception capacity, by utilizing an AESA array in a node in the wireless network, where the AESA is coupled to a controller for controlling independent TRMs of the AESA. The controller selects a subset of the modules dynamically in response to the UE provided UE RF channel feedback, via a logical control channel, RF channel feedback being used for adjusting the phase alignment of the modules and optimize the aggregate power level to maximize the data transfer rate, where the phase alignment controls the direction of transmission of compatible RF signals to the UE and the number of selected set of modules controls the sharpness of the signal and the aggregate power targeted at the UE.

In a further aspect of the present invention a controller is introduced. The controller controls multiple subsets of TRMs of the AESA array, where each subset is a group of TRMs selected based on their location, geometry, and distance to each other measured as a function of the said RF wavelength in response to the UE provided RF channel feedback. Each subset of TRMs transmits according to a specific wireless technology standard, including GSM, WCDMA, CDMA, WiMAX, LTE, and their evolved standards to the UE capable of receiving and transmitting in the compatible technology. The selection of these TRM subsets are dynamic and based on the current RF environment characterized by the RF parameters in the system including the UE RF channel feedback. The single Base Station supports multiple wireless technology standards at the same time by selecting different TRM subsets and transmitting the said technology standard over each subset. The controller includes broadcasting and detecting means for the particular radio technology of the UE and scheduling logic operating in a processor with an associated memory that selects one of the plurality of physical or logical sub-controllers that corresponds with the radio technology of the UE. Each sub-controller comprises the logic means for selecting one or more transmission modules in the shared pool of such modules of the AESA to transmit a part of or a full frequency band specific to the UE. The number, location, geometry, and distance, to each other of these modules, measured as a function of the said RF wavelength in response to the UE provided UE RF channel feedback, via a logical control channel, are controlled to optimize the desired direction of transmission to the UE and the aggregate power targeted at the UE to maximize the data transfer rate.

In a further aspect of the present invention a system providing increased transmission capacity in a wireless network comprises a user equipment (UE) in communication with a Base Station capable of at least one of GSM, WCDMA, CDMA, WiMAX, LTE, and their evolved technology standards. The BS comprises an (AESA) array, for transmitting and receiving RF radio frequency signals to and from the UE in the compatible technology standards. The UE contains TxMs and RxMs and transmits at least one logical control channel to provide its RF channel feedback, for example, its location and geographical information to the BS and a channel matrix that includes information of its estimate of the condition of the RF channels in the direction from the BS to the UE.

In another aspect of the present invention a system providing increased transmission capacity in a wireless network comprises a user equipment (UE) in communication with a Base Station capable of at least one of GSM, WCDMA, CDMA, WiMAX, LTE, and their evolved technology standards. The BS comprises an (AESA) array, for transmitting and receiving RF radio frequency signals to and from the UE in the compatible technology standards. The UE contains TRMs and transmits at least one logical control channel to provide its RF channel feedback, for example, its location and geographical information to the BS and a channel matrix that includes information of its estimate of the condition of the RF channels in the direction from the BS to the UE.

### BRIEF DESCRIPTION OF THE SEVERAL VIEWS OF THE DRAWINGS

The novel features believed characteristic of the invention are set forth in the appended claims. The invention will best be understood by reference to the following detailed description of an illustrative embodiment when read in conjunction with the accompanying drawings, wherein:

FIG. 1 is a military AESA radar installation in an F-22 Raptor Fighter;

FIG. 2, depicts a block diagram of an AESA radar antenna, wherein each “pin” is an AESA transmitter/receiver module;

FIG. 3, illustrates a high level block diagram of each TxM being connected to a phase shift module (PSM) that provides a controllable phase shift of the RF signal;

FIG. 4a depicts two-sine waves that when perfectly aligned in phase multiply the signal;

FIG. 4b illustrates the effect when two sine waves are perfectly out-of phase signals;

FIG. 5 depicts the additive effect of multiple Transmitter modules transmitting in phase;

FIG. 6 illustrates channel update as transmitted from the UE at regular intervals;

FIG. 7a depicts a high level block diagram of a network in accordance with the present invention;

FIG. 7b illustrates a User Equipment;

FIG. 7c depicts a high level block diagram of a Base Station;

FIG. 8a depicts a high level block diagram of a Base Station incorporating an AESA antenna configuration in accordance with a preferred embodiment of the invention;

FIG. 8b illustrates a high level block diagram of the Active Electronic Scanned Array (AESA) configuration in a Base Station in accordance with a preferred embodiment of the present invention;

FIG. 9 is a high level flow chart for a process of utilizing a AESA in accordance with a preferred embodiment of the present invention; and

FIG. 10 depicts the Base Station transmission power in at least four different directions, each having the same spatial signature in accordance with a preferred embodiment of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

The functionality can be implemented by means of hardware comprising several distinct elements and by means of a suitably programmed processing apparatus. The processing apparatus can comprise a computer, a microprocessor, a state machine, a logic array or any other suitable processing apparatus. The processing apparatus can be a general-purpose processor which executes software to cause the general-purpose processor to perform the required tasks, or the processing apparatus can be dedicated to perform the required functions. Another aspect of the invention provides machine-readable instructions (software) which, when executed by a processor, perform any of the described methods. The machine-readable instructions may be stored on an electronic memory device, hard disk, optical disk or other machine-readable storage medium. The machine-readable instructions can be downloaded to a processing apparatus via a network connection.

Abbreviations

3GPP 3rd Generation Project Partnership

3GPP2 3rd Generation Project Partnership 2

AESA Active Electronic Scanned Array

BTS Base Transceiver Station

CDMA Code Division Multiple Access

CQI Channel Quality Indicator

CSI Channel State Indication

DL Downlink

DRC Data Rate Control

FDMA Frequency Division Multiple Access

GPS Global Positioning System

HRPD High Rate Packet Data

HSDPA High Speed Downlink Packet-Data Access

LTE Long Term Evolution (3GPP)

MIMO Multiple-In Multiple-Out

OFDMA Orthogonal Frequency Division Multiple Access

PN Pseudo-sequence Number

PSM Phase Shift Module

RF Radio Frequency

Rx Receive

RxM Receiver Module

SC-FDMA Single Carrier-Frequency Division Multiple Access

TDMA Time Division Multiple Access

TRM Transmitter/Receiver Module

Tx Transmit

TxM Transmitter Module

UE User Equipment

UL Uplink

UMTS University Mobile Telecommunications System

WIMAX Worldwide Interoperability for Microwave Access

WCDMA Wide-Band CDMA

Active Electronic Scanned Array (AESA), is a key wireless technology in modern radar and typically requires a massive amount of compute-power to control and manage AESA transmission and reception. It is expected by the time of 4G wireless networks and beyond, the required computing power and the related AESA cost issues will be resolved due to continued progress in electronics and semiconductor technologies. Adapting the AESA technology to a mobile or fixed wireless network can provide many times of capacity increase in the downlink and uplink. AESA technology, when applied to wireless transmission equipment can improve capacity by utilizing thousands of transmitter modules in the Base Station and can devote as many transmitter modules to each user as needed and as permitted within the coverage of a cell. The cost of such equipment is currently high but, it is already trending down and with mass commercialization, the equipment would become affordable.

AESA transmission and reception can be designed to be directional towards individual User Equipment (UE). By increasing the number of transmitter modules that work together, the network can support users further and further away from the cell center as long as the uplink transmit technology from the user permits. And equally, it can scale up the amount of data transmitted to the user (or a group of users), depending on the RF environment of each user, by steering more transmitter modules towards the user in one or more specific directions. The capacity that can be exploited is potentially large as the transmission power can be scaled with more transmission modules and time-sharing the transmission of data to many users in many directions.

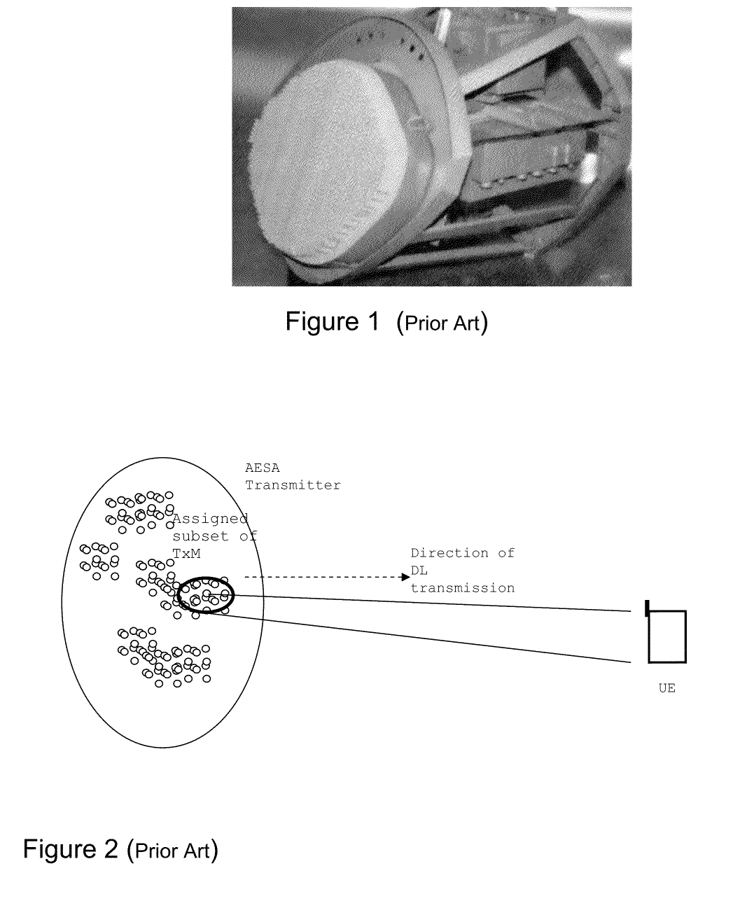

FIG. 1 is a photograph of a military AESA radar installation in an F-22 Raptor Fighter. The application of AESA technology, to date, has not been used in the commercial wireless communications field. However, with progress made in solid state electronic components, AESA transmitters have become much smaller and, with mass commercialization, trending to becoming more affordable.

FIG. 2, illustrates a block diagram of an AESA radar antenna, wherein each of the multitude of pins as shown in FIG. 1 are represented by the small circles, each of the circles representing an AESA transmitter/receiver module (TxM/RxM). Note the “pins” should fill the AESA transmitter panel or panels, though not all are depicted in the figure. In an advanced fighter plane such as the F35, part of the AESA array can be directed for point-to-point high capacity data link communications. Each TxM consumes very little power, a few hundred milli-watts up to a few watts.

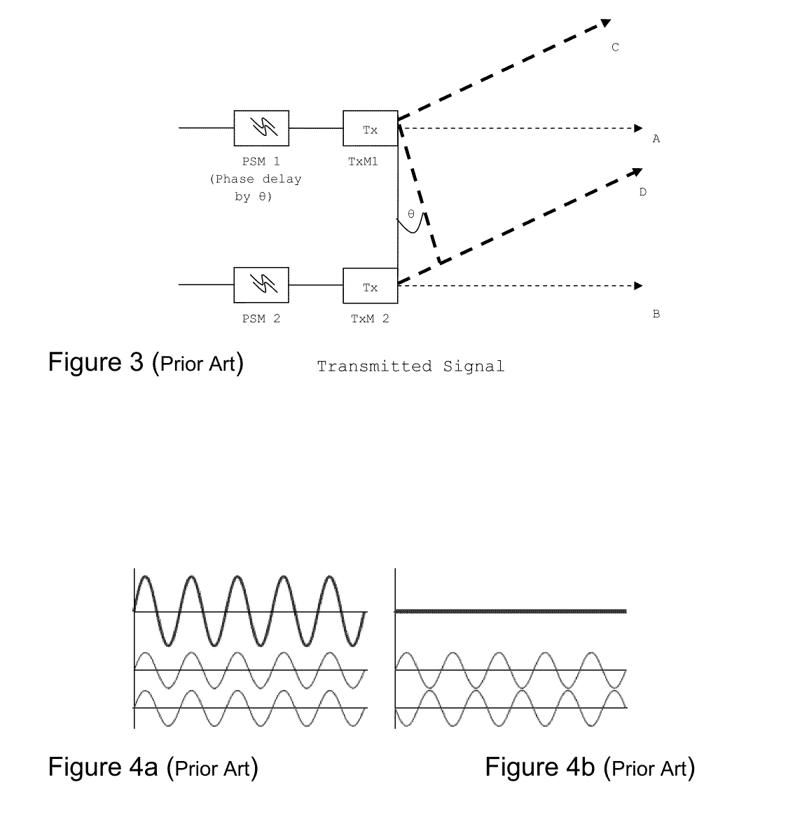

FIG. 3 depicts each TxM connected to a phase shift module (PSM) that provides a controllable phase shift of the RF signal. (The PSM can be a separate device or contained within the TxM.) A subset of the TxMs can be targeted in a specific direction towards a User Equipment (UE) where the Tx signal from each TxM overlaps in space and interferes constructively to reinforce the signal in this specific direction; this is done by controlling the PSM phase shift of the transmitted signal from each TxM. In a simple case, a TxM may transmit a narrow-band simple sine-wave form signal. Constructive interference between signals from different modules, when phase controlled, reinforces the signal in the desired direction. The Tx modules are controlled as a subset to a user and in time, where a control channel with the AESA array or any traditional 3G/4G technology is used for timing alignment, network signaling, and resource scheduling.

The target of the transmitted signal is a mobile or fixed wireless device generically referred to as a User Equipment (UE). The AESA Tx modules (TxM) are part of the Base Station transceiver system (BS), which utilizes the TxMs to schedule and transmit data to the UE.

Each of the TxMs is controlled so as to be phase aligned such that signals from the subset of TxMs interfere constructively (signals are additive) in the direction of a User Equipment and within a computed distance of the UE from the Base Station cell center. The UE transmits its RF channel feedback in the UL, including Channel State Information (CSI), including that for the DL channel to the UE and that for the UL channel from the UE, the accepted data rate from the Base Station to the UE, the transmitted data rate from the UE to the Base Station, and the position information of the UE transmitted signal, including, location, elevation, and orientation so that the TxM can be steered to transmit accurately to the UE even when it is mobile.

For example, by delaying the phase shift of some TxM elements in relation to other modules in a particular group of Tx modules, the direction of the transmitted signal is steered by the angle of θ as shown in FIG. 3. Note, there are no moving parts in the steering of the transmission direction of the desired signals as the modules are electronically steered rather than being steered mechanically, which reduces the need for maintenance.

Each cell or sector within the wireless network has one or more AESA panels coupled with one or more Base Stations (see FIG. 2). The more TxM and RxM modules in the array the higher the potential transmission capacity, being limited only by the electric power supply, the space to accommodate the AESA, and the range of the transmission frequency band.

As illustrated in FIG. 4a, two-sine waves multiply when perfectly aligned in phase. The signal strength almost doubles, hence even though an individual TxM power may be low, the cascaded transmit power of a group of aligned TxMs becomes large and can target a UE from a significant distance (however the signal will still attenuate in free space exponentially). The opposite is true when two sine-waves are out of phase as in FIG. 4(b), where perfectly out-of phase signals sum to zero.

The phase shift is done in such a manner as to delay some of the TxM signals within the same subgroup where the signal phase aligns in a specific direction, resulting in constructive interference. In other directions, the signals interfere destructively and hence the signal is degraded. Because each TxM module transmits a small amount of power, the direction of constructive interference cascades and produces a stronger signal. The direction of non-constructive interference transmits no more than a few hundred meters before signals dissipate through attenuation in free space.

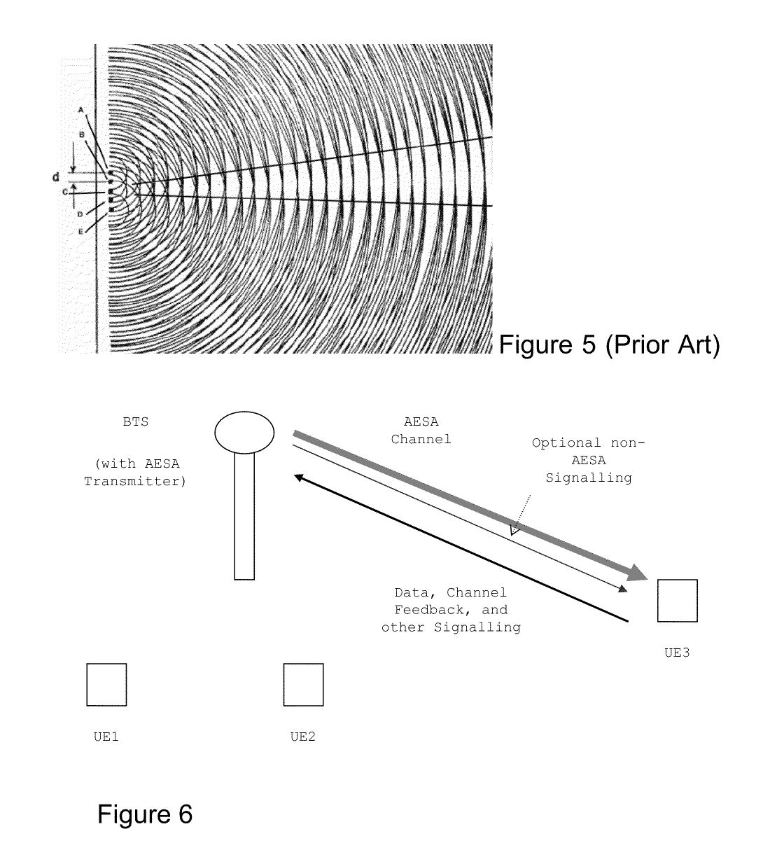

FIG. 5 illustrates the additive effect of multiple TxM transmitting in phase, where the signal is strengthened (i.e., appearing brighter) in the direction of the phase alignment.

The number of TxM modules required can be determined from a desired signal strength, which determines a modulation and coding scheme (hence the achievable data rate) and the expected attenuation of the signal in the transmission environment given the distance to the target receiver and the RF channel. Note there are other factors that limit the number of TxMs being added, for example, the Uplink (UL) transmission from the UE and the desired cell sizes. The estimate of the number of modules required can be computed from channel feedback from the UE in the UL The more TxMs are allocated to a target, the stronger the multiplied signal strength is, hence the higher modulation and coding scheme, or the further away the receiver may be located.

The Tx direction can be determined from periodic channel feedback by the UE in the UL direction. As illustrated in FIG. 6, channel feedback update is transmitted from the UE at regular intervals to ensure that the BS has up to date information to determine the direction of the transmission to the UE.

In the simplest form, the TxM transmits a narrow band sine-wave signal that time-multiplexes a reference pilot signal with a predetermined modulation and coding scheme and bit sequence and payload data to the target UE. For GSM, CDMA, WCDMA, OFDMA (e.g., LTE and WiMAX), the respective transmitted signal waveform apply to that specific technology.

Each TxM module is an independent transmitter in the sense that it can be controlled to transmit a specific frequency at a time, and the directionality of the DL transmission is such that there is a high level of frequency reuse within the same network cell. Each TxM is capable of transmitting at a wide range of frequencies so that a Pseudo-random Number (PN) sequence may be used to control the transmission to use frequency-hopping for diversity gain and interference robustness of the design.

In the UL, the direction of transmission and channel feedback are reversed. In particular, the channel feedback includes Channel State Information (CSI), including that for the UL channel to the Base Station and that for the DL channel from the Base Station, the accepted data rate from the UE to the Base Station, the transmitted data rate from the Base Station to the UE, and the position information of the Base Station transmitted signal, including, location, elevation, and orientation. However, the same principles apply. In the UL the UE is the transmitter and the Base Station is the receiver. The Base Station Rx modules are steered in phase to align to a direction of the transmitted signal from the UE. This has the benefit of optimizing the desired signal in specific signal paths and direction, and minimizing any interference from other directions. A subset of RxMs can be controlled according to specific separation, as a function of the frequency wavelength, for a particular UE to maximize receive diversity or to maximize data rate.

The DL and UL transmitted signal may employ any existing wireless technologies, including CDMA, CDMA EVDO, WCDMA, and OFDMA (e.g., LTE and WiMAX) as defined by 3GPP and 3GPP2. A specific channel in the UL (or DL) direction is employed for signaling the channel feedback, and it may also be used for scheduling of resources for the DL (or UL) direction using any of these existing wireless technologies. The Base Station (or the UE) transmission direction can be adjusted in response to the channel feedback from the UE (or the Base Station), typically within milliseconds, to ensure adaptation to RF conditions and to keep up with UE mobility.

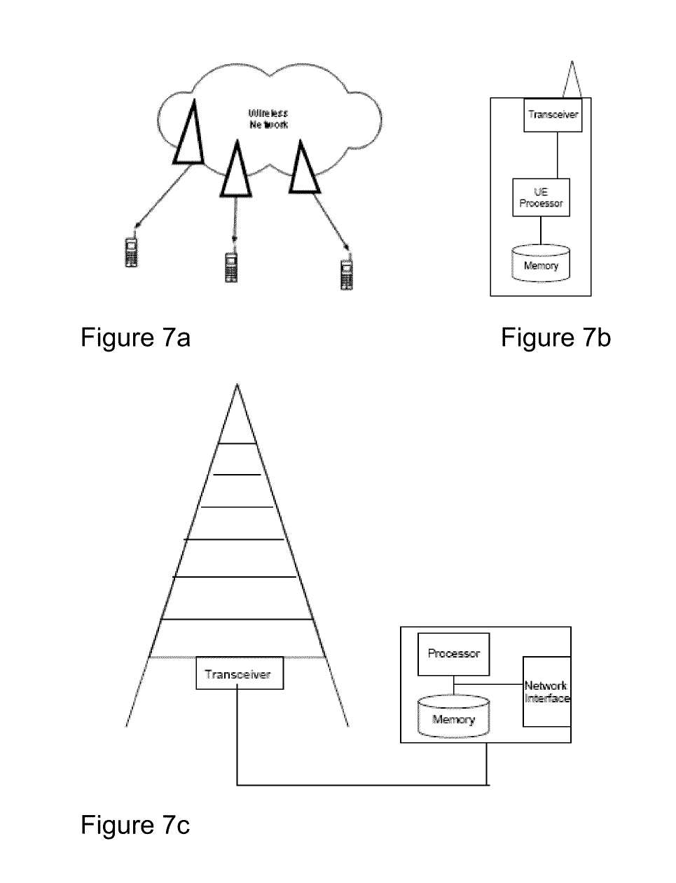

FIG. 7a depicts a high level block diagram of a network in accordance with the present invention. The network can include one or more instances of user equipment (UEs) and one or more Base Stations capable of communicating with these UEs, along with any additional elements suitable to support communication between UEs or between a UE and another communication device (such as a landline telephone). Although the illustrated UEs may represent communication devices that include any suitable combination of hardware and software, these UEs may, in particular embodiments represent devices such as the example UE illustrated in greater detail by FIG. 7b. Similarly, although the illustrated Base Stations represent network nodes that include any suitable combination of hardware and software, these Base Stations may, in particular embodiments, represent devices such as the example Base Station illustrated in greater detail by FIG. 7c.

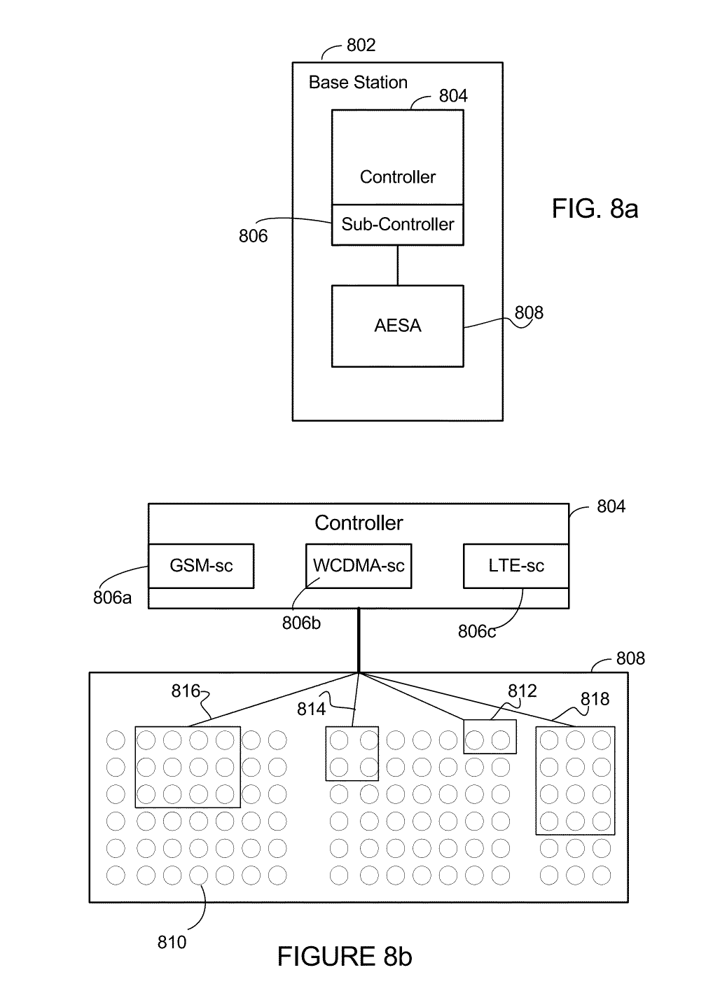

FIG. 7b illustrates an example UE which includes a microprocessor, a memory, a transceiver, and an antenna. In particular embodiments, some or all of the functionality described above as being provided by mobile communication devices or other forms of UE may be provided by the UE processor executing instructions stored on a computer-readable medium, such as the memory shown in FIG. 7b. Alternative embodiments of the UE may include additional components beyond those shown in FIG. 8 that may be responsible for providing certain aspects of the UE's functionality, including any of the functionality described above and/or any functionality necessary to support the solution described above.

As depicted in FIG. 7b, the example Base Station includes a microprocessor, a memory, a transceiver, and an antenna. In particular embodiments, some or all of the functionality described above as being provided by a mobile Base Station, a Base Station Controller, a Node B, an enhanced Node B, or any other type of mobile communications node executing instructions stored in the memory. Alternative embodiments of the Base Station may include additional components responsible for providing additional functionality, including any of the functionality identified above and/or any functionality necessary to support the solution described above.

FIG. 8a depicts a high level block diagram of a Base Station incorporating an AESA antenna configuration in accordance with a preferred embodiment of the invention. Base Station 802 includes controller 804, which manages sub-controller 806 which, in turn, controls the transmitter and receiver modules of AESA 808. The sub-controller may control and operate the TxMs and RxMs individually, in pairs or in groups of modules. Not pictured are UEs and the rest of the network of which Base Station 802 is an integral part. Even though there is only one sub-controller 806 shown for ease of explanation, there can be multiple sub-controllers that are controlled by controller 804. As will be shown in FIG. 8b, sub-controllers representing various and different radio access technologies can be simultaneously controlled both for transmitting and receiving. The AESA Base Station may be considered a “universal” Base Station as virtually any radio access technology may be handled at the same time both receiving and transmitting. This feature of the invention could give rise to an independent, single Base Station operator entity that can serve multiple telecom operators at the same time.

FIG. 8b illustrates a high level block diagram of the AESA antenna configuration in a Base Station in accordance with a preferred embodiment of the present invention. High capacity AESA 808 is managed by controller 804, which includes a number of sub-controllers for controlling various wireless technologies, three of which are illustrated here. Because of room and clarity of explanation only three technologies are represented here and include GSM-sc (GSM subcontroller) 806a, WCDMA-sc 806b and LTE-sc 806c. The number of sub-controllers is limited only by available space and power requirements of AESA 808. Various TxM/RxM pairs can be taken over and controlled by the individual subcontrollers on an as needed and as available basis. In other words, if a pair of TxM/RxM (previously used by GSM-sc) is now idle and a need arises for LTE transmission and reception, LTE-sc 806c may be utilized by controller 804 to connect, e.g., Tx group 812 to an LTE enabled wireless communications device.

AESA 808 consists of a large number of low-powered, independent transmitter modules (TxM) 810 and a similarly large number (but not necessarily the same number) of independent receiver modules (RxM). Sub-controllers can take over various groups of transmitters and/or receivers (e.g., 812, 814, 816 and 818) in response to a UE's requirement for signal power. Because each TxM and RxM is independently controlled and can be spatially separated flexibly, a subset or subsets of TxM (or RxM) can be steered through phase-shift electronically using phase shift module (not shown) for beam-forming, Tx/Rx diversity, or spatial multiplexing to each UE within the coverage area of AESA 808. A controlling algorithm has the flexibility to choose from a large number of active Tx/Rx module pairs or groups as well as applying different transmission methods to these subsets of modules.

The TxM and RxM are active and are independently (in frequency, phase, and power) steered utilizing the aforementioned phase shift module. The pairs or groups of TxM and RxM are utilized on an as-needed basis in subsets to the overall set of modules to support multiple UEs, each UE possibly using a different radio access technology, that are accessing the network. Since the modules are strategically separated spatially, flexibility is afforded by the reach (i.e., power level when interfering constructively) and Tx/Rx direction (i.e., phase shift).

The TxM and RxM modules may be physically combined as a TRM, thus each module in FIG. 8a and FIG. 8b is capable of transmitting in the DL, and receiving in the UL. Similar to the TxM and RxM each TRM module can be individually steered by the controller, but the transmit and receive direction will be the same.

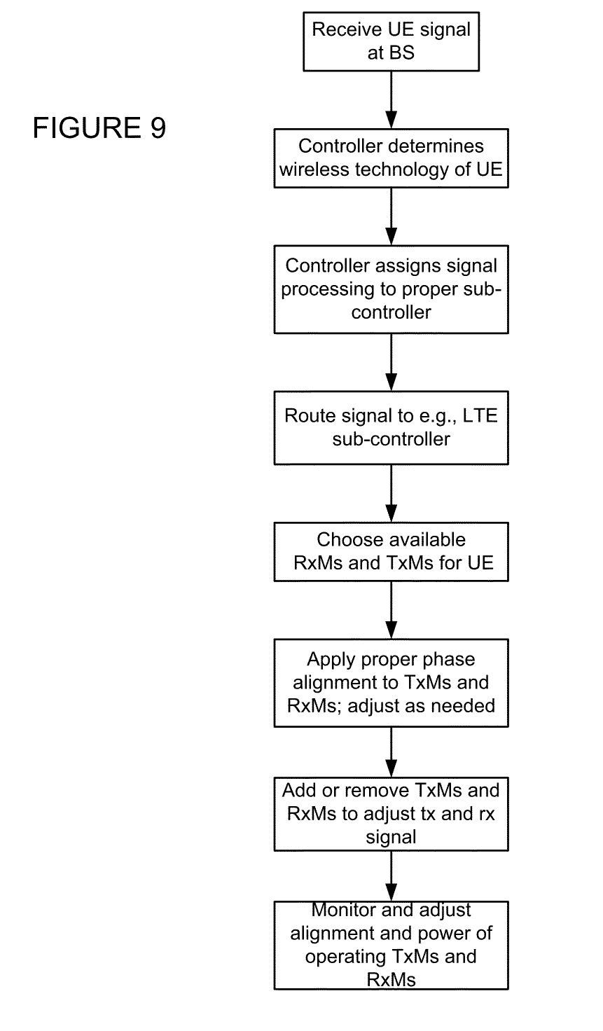

FIG. 9 is a high level flow chart for a process of utilizing a AESA in accordance with a preferred embodiment of the present invention. The steps in this process are for an AESA having separate TxM and RxM modules. In a process involving TRMs (combination of TxM and RxM), the steps are similar and will not be recited here. The process involving TxM and RxM modules begins at step 902 with the reception of a signal (including control channels, traffic channels, channel feedback, and pilot signal) from a User Equipment (UE) at a Base Station in which an AESA is incorporated. The process then moves to step 904 where a controller for the AESA determines the wireless technology of the UE signal. Typically the UE registers with the system as it enters the system, including one or more of wireless technologies that it supports.

Next, the process proceeds to step 906 with the controller directing the signal to a sub-controller that handles the wireless technology of the UE. The wireless technologies that are handled by the Base Station in which AESA is installed may include CDMA, GSM, WCDMA and LTE. The ability to handle the different technologies is found in selecting available transmitter modules that are spaced a distance apart as a function of the wavelength of the operating frequency of the UE. Any of the modules, receiver or transmitter, can be used to carry signals to and from almost any UE because of the ability to select the spacing of the transmitting and receiving modules.

The sub-controller allocates frequencies and time slots for the transmission to and reception from the UE. It also determines the direction of the transmission and reception using data received from the UE RF channel feedback. More TxM modules are used for higher signal strength, and for a more sharply focused signal, specifically spaced TxM modules and the individual phase shifts are used for the transmission direction. Similarly, more RxM modules for higher gain, and specifically spaced RxM modules and the phase shifts for the direction. After the TxMs are chosen, the process moves to step 910, where phase alignment is applied to the group of TxMs for transmission and RxMs for receiving. In the next step, step 914, as the UE changes direction and distance from the Base Station, the Base Station continues to monitor the UE, and the process restarts from 902 again, where the number of TxMs and RxMs, phase alignment of each module, overall power, and overall gain, in UL and DL, are constantly adjusted by the sub-controller so as to maintain or increase data transfer.

In step 916, as the UE using GSM wireless technology leaves the cell covered by the Base Station, another UE using LTE may enter the same cell. As the Tx modules are now idle, the LTE controller can utilize the vacant Tx and Rx modules for the LTE controller. If the GSM UE is in the cell when the LTE UE is acquired by the AESA Base Station, the LTE sub-controller selects idle RxM and TxM modules to connect to the LTE UE. As multiple UEs enter the cell, depending on the availability of Tx and Rx modules, all of the UEs regardless of wireless technology, can be served by the AESA Base Station.

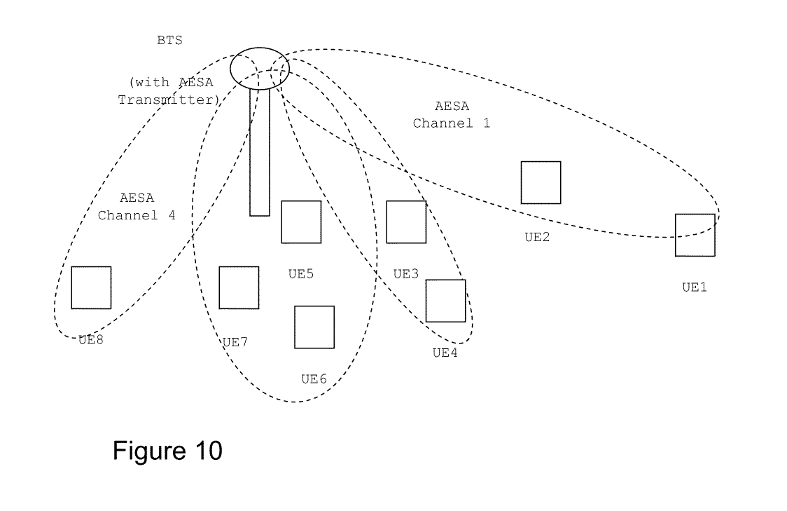

FIG. 10 shows that the Tx power to the UEs in the same spatial signature group can be precisely controlled to multiplex many UEs in the same direction, which allows data rate maximization overall in the coverage area of the cell, and the power of different frequencies being limits to achieve a balanced data rate to the target UEs, while at the same time to reduce the interference to adjacent cells. Using LTE as an example, which uses OFDMA signals and have some very attractive properties, each TxM (or RxM) module group can be modulated with OFDM symbols to multiplex more users with the same spatial signatures as captured by channel feedback. The multiplexed OFDM signals may compose of many frequencies, have the same direction, and may have different power for each subset of frequencies.

In each direction, a specific AESA channel can be formed with reduced interference between channels. The lope of the channel can be controlled to be narrower or wider depending on the covered area and UEs as needed by controlling more or fewer TxM and RxM modules and their spacing on the AESA arrays. The important aspect of this Base Station architecture using the AESA is that each channel can be dynamically constructed depending on the need as obtained from the channel feedback from the UE. In fact, the different channels are omni-directional and spans different directions across 360 degrees and from the ground to the required elevation at different times and for different UEs.

Each channel can be transmitting one of the supported wireless technologies, i.e., GSM, CDMA, WCDMA, LTE, WiMAX, and their derivatives.

Although the described solutions may be implemented in any appropriate type of telecommunication system supporting any suitable communication standards and using any suitable components, particular embodiments of the described solutions may be implemented in a network, such as that illustrated in FIG. 7.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims

What is claimed:

1. An apparatus for increasing the capacity of data transmission and data reception in a wireless network, the apparatus comprising:
a plurality of user equipments (UEs);
a base station comprising:
an Active Electronic Scanned Array (AESA), the AESA comprising:
a plurality of transmitter modules (TxMs), for transmitting a signal to a specific UE, each of the TxMs for use with at least one other corresponding TxM, each being spaced apart a distance equal to a function of a Radio Frequency (RF) wavelength used by the specific UE; and
a plurality of receiver modules (RxMs), for receiving a signal from the specific UE, each of the RxMs for use with at least one other corresponding RxM, each being spaced apart a distance equal to a function of the RF wavelength used by the specific UE; and
a controller comprising:
an interface for connecting to and managing a sub-controller wherein the sub-controller is coupled with the plurality of TxMs and the plurality of RxMs, the sub-controller steering a phase alignment of the at least two TxMs for transmitting and the at least two RxMs for receiving signals from and to the specific UE, the sub-controller
determining a number of TxMs for providing in increased signal strength for increased data transfer and increased available range to the specific UE; and
determining a number of RxMs for receiving signals from the specific UE with a higher gain.

2. The apparatus of claim 1, wherein the controller further comprises:
a receiver for receiving a logical control channel carrying the channel feedback in the UL from the specific UE so as to determine the number of TxMs and adjust phase alignment of these TxMs for sending signals to the specific UE;
a transmitter for transmitting the logical control channel carrying the channel feedback in the DL from the Base Station to the specific UE to allow the specific UE to determine the number of TxMs of the UE and adjust phase alignment of UE TxMs to transmit signals to the AESA; and
a phase shift module for directing the phase alignment of selected groups of TxMs for increasing signal strength at the AESA, or groups of RxMs for increasing signal strength at the UE, the increased signal strength providing increased range, increased gain and increased data transmission between the base station and the specific UE.

3. The apparatus of claim 2, wherein the controller responds to the channel feedback from the specific UE by selecting a proper number of TxMs to meet the requested increase in data transmission to the specific UE.

4. The apparatus of claim 2, wherein the controller responds to the channel feedback from the specific UE by determining the position of and spacing between the TxMs for direction and span of the transmitted signal to meet the requested increase in data transmission to the specific UE.

5. The apparatus of claim 2, wherein the controller responds to the channel feedback from the specific UE by selecting a proper number of RxMs to meet the requested data transmission from the specific UE.

6. The apparatus of claim 2, wherein the controller responds to the channel feedback from the specific UE by determining the position of and spacing between the RxMs for direction and span of the received signal to optimize received signal gain.

7. The apparatus of claim 2, further comprising:
a transmitter for transmitting from the specific UE to the Base Station, via the logical control channel, the channel feedback in the UL having channel Channel State Information (CSI), including that for the DL channel to the UE and that for the UL channel from the UE, the accepted data rate from the Base Station to the UE, the transmitted data rate from the UE to the Base Station, and the position information of the UE transmitted signal, including, location, elevation, and orientation, causing the Base Station to adjust a TxM phase alignment for optimally transmitting signals to the UE and RxM phase alignment for optimally receiving signals from the UE.

8. The apparatus of claim 2, further comprising:
a transmitter for transmitting from the Base Station to the UE, via the logical control channel, the channel feedback in the DL having Channel State Information (CSI), including that for the UL channel to the Base Station and that for the DL channel from the Base Station, the accepted data rate from the UE to the Base Station, the transmitted data rate from the Base Station to the UE, and the position information of the Base Station transmitted signal, including, location, elevation, and orientation, causing the UE to adjust a transceiver phase alignment for optimally transmitting signals to the Base Station and receiving signals from the Base Station.

9. The apparatus of claim 1, the AESA further comprising:
a plurality of transmitter and receiver modules (TRM) each TRM comprising a TxM and a RxM.

10. A method for increasing transmission and reception capacity in a wireless network, the method comprising the steps of:
utilizing an Active Electronic Scanned Array (AESA) in a node in the wireless network, wherein the AESA is coupled to a controller for controlling independent transmitter modules (TxM) and receiver modules (RxM) in the AESA,
the node receiving from a User Equipment (UE), via a logical control channel, channel feedback for the UE, the channel feedback being used for adjusting a phase alignment of the AESA Tx modules;
the controller selecting a sub-controller consistent with the UE radio frequency and the supported wireless technologies, wherein the sub-controller selects appropriate transmitter modules for accurately transmitting wireless radio signals to the specific UE according to signal strength, data transfer and range requirements for the UE.

11. The method of claim 10, further comprising
the subcontroller adjusting the number of Tx modules transmitting to the UE as required wherein an increased number of TxMs directed to the UE provides a stronger signal for greater data transfer and a longer available range to the specific UE;

12. The method of claim 10, further comprising the step of the AESA transmitting a logical control channel containing the channel feedback in the DL from the Base Station to the UE, having Channel State Information (CSI), including that for the UL channel to the Base Station and that for the DL channel from the Base Station, the accepted data rate from the UE to the Base Station, the transmitted data rate from the Base Station to the UE, and the position information of the Base Station transmitted signal, including, location, elevation, and orientation, being used to allow the UE to adjust a phase alignment of its TxMs for accurately transmitting signals to the Base Station and of its RxMs for receiving signals from the Base Station;

13. The method of claim 10, further comprising the step of the UE transmitting a logical control channel containing the channel feedback in the UL from the UE to the Base Station, having channel Channel State Information (CSI), including that for the DL channel to the UE and that for the UL channel from the UE, the accepted data rate from the Base Station to the UE, the transmitted data rate from the UE to the Base Station, and the position information of the UE transmitted signal, including, location, elevation, and orientation, being used to allow the Base Station to adjust a phase alignment of its TxMs for accurately transmitting signals to the UE and of its RxMs for receiving from the UE.

14. The method of claim 10, the AESA being coupled to a controller for controlling independent transmitter and receiver modules (TRM) each TRM being composed of a TxM and a RxM.

15. A base station in a wireless telecommunications network for supporting transmission and reception wireless devices called User Equipment (UE) each having one or more of a plurality of radio access technologies including GSM, CDMA, WCDMA, WiMAX and LTE, the base station comprising:
an Active Electronic Scanned Array (AESA) transceiver for transmitting and receiving radio signals between a UE and the base station;
a controller for controlling the AESA;
a plurality of sub-controllers, each sub-controller dedicated to a single radio technology;
detecting means for determining the particular radio technology of the UE;
scheduling means for
selecting one of the plurality of sub-controllers that corresponds with the radio signal received from the UE, wherein each sub-controller comprises
logic means for selecting one or more transmission modules in the AESA to transmit a part of or a full frequency band specific to the UE, wherein the number and separation of transmission modules used is proportional to the strength of the transmitted signal and the selection of the one or more transmission modules depends on the location of the UE taking into account the channel feedback from the UE signal with respect to the AESA.

16. The controller of claim 15, wherein each sub-controller can control Tx modules (TxM) and Rx modules (RxM) either together or separately.

17. The controller of claim 15, wherein each of the one or more Tx modules (TxM) can transmit different types of signals including GSM, CDMA, WCDMA, WiMAX, or LTE over part or a full frequency band, and each of the one or more Rx modules (RxM) can receive different types of signals including GSM, CDMA, WCDMA, WiMAX, or LTE over part or a full frequency band.

18. The controller of claim 15, wherein a Tx modules (TxM) and a Rx modules (RxM) are physically combined into a transmitter and receiver module (TRM).

19. The controller of claim 15, wherein the sub-controller selected by the controller for managing the UE's specific signal is adapted for selecting the transmission modules and receiver modules from the available modules of the AESA such that the UE's specific radio technology determines the selection of the available modules for a required angular direction for transmission and receiving.
any group of transmitting modules can transmit signals of any one of the different wireless technologies at a particular time,
a group of TxMs may be scheduled to transmit a different technology at another time depending on the in-structions of the controller,
a group of RxMs may be scheduled to receive a different technology at another time depending on the instructions of the controller,
the controller determines which TxMs and RxMs and which group of such TxMs transmit and RxMs receive a particular radio technology based on the requirements of the transmission and reception

20. A system for providing increased transmission capacity in a wireless network, the system comprising:
a user equipment (UE) in the wireless network in communication with
a base station that comprises:
an Active Electronic Scanned Array (AESA), for transmitting and receiving radio frequency (RF) signals to and from the UE;
a controller coupled with the AESA for choosing and aligning one or more of a plurality of independent AESA transmitter modules (TxMs), the TxMs being chosen based on a determined spacing between the TxMs according to the wavelength of the UE's RF, and receiver modules (RxMs), the RxMs being chosen based on a determined spacing between the RxMs according to the wavelength of the UE's RF, the controller including
multiple sub-controllers, each sub-controller being specific to a particular wireless technologies, and
phase alignment means for aligning the one or more of a plurality of independent TxMs to provide greater or lower signal strength and for the purpose of transmitting to a specific User Equipment (UE), and phase alignment means for aligning the one or more of a plurality of independent RxMs to provide greater or lower signal gain and for receiving from a specific User Equipment (UE).

21. The System of claim 20, wherein the controller further comprises one or more sub-controllers each sub-controller supporting a wireless technology including GSM, CDMA, WCDMA, WiMAX or LTE.

22. The system of claim 20, wherein the controller may transmit and receive one or more of the RF signals utilizing chosen groups of TxMs and RxMs, wherein the one or more RF signals are handled by one of the plurality of sub-controllers such that the base station can support, simultaneously, any wireless technologies including GSM, CDMA, WCDMA, Wi-Max or LTE.

23. The system of claim 20, wherein the TxMs and RxMs are agnostic and if one or more TxMs or RxMS are inactive, the controller can assign the inactive one or more TxMs and RxMs to a wireless technology different from the previously assigned wireless technology.

24. The system of claim 20, wherein a TxM and a RxM are physically combined into a Transmitter and Receiver Module (TRM).

25. A method for providing enhanced transmission capacity in a wireless network, the method comprising the steps of:
utilizing an Active Electronic Scanned Array for transmitting and receiving radio frequency (RF) signals from user equipment, and
a controller coupled with the AESA for choosing and aligning one or more of a plurality of independent AESA transmitter modules (TxMs), the TxMs being chosen based on a determined spacing between the TxMs according to the wavelength of the UE's RF, and receiver modules (RxMs), the RxMs being chosen based on a determined spacing between the RxMs according to the wavelength of the UE's RF, the controller including
multiple sub-controllers, each sub-controller being specific to a particular wireless technologies, and
phase alignment method for aligning the one or more of a plurality of independent TxMs to provide greater or lower signal strength and for the purpose of transmitting to a specific User Equipment (UE), and phase alignment method for aligning the one or more of a plurality of independent RxMs to provide greater or lower signal gain and for receiving from a specific User Equipment (UE).

26. The Method of claim 25, wherein the controller further comprises one or more sub-controllers each sub-controller supporting a wireless technology including GSM, CDMA, WCDMA, WiMAX or LTE.

27. The Method of claim 25, wherein the controller may transmit and receive one or more of the RF signals utilizing chosen groups of TxMs and RxMs, wherein the one or more RF signals are handled by one of the plurality of sub-controllers such that the base station can support, simultaneously, any wireless technologies including GSM, CDMA, WCDMA, WiMax or LTE.

28. The Method of claim 25, wherein the TxMs and RxMs are agnostic and if one or more TxMs or RxMS are inactive, the controller can assign the inactive one or more TxMs and RxMs to a wireless technology different from the previously assigned wireless technology.

29. The Method of claim 25, wherein a TxM and a RxM are physically combined into a Transmitter and Receiver Module (TRM).
